(19) United States
(12) Patent Application Publication
(10) Pub. No.: US 2014/0302219 A1
(43) Pub. Date: Oct. 9, 2014

(54) METHOD FOR PRODUCING A MILK PRODUCT

(71) Applicant: VALIO LTD., Helsinki (FI)

(72) Inventors: Reetta Tikanmäki, Helsinki (FI); Matti Erkki Harju, Nummela (FI); Olli Tossavainen, Espoo (FI)

(21) Appl. No.: 14/357,354

(22) PCT Filed: Nov. 9, 2012
(86) PCT No.: PCT/FI2012/051097

§ 371 Date: May 9, 2014

(30) Foreign Application Priority Data
Nov. 11, 2011 (FI) 20116120

(51) Int. Cl. A23L 1/29; A23L 1/305

(52) U.S. Cl. CPC A23L 1/296; A23L 1/3056
USPC 426/580; 426/491; 426/471; 426/590; 426/657

(57) ABSTRACT

A method is disclosed for producing an infant formula base, wherein by means of microfiltration, ultrafiltration, and nanofiltration the components of milk are separated into a casein fraction, a whey protein fraction, and a lactose fraction to produce, by suitably combining, a composition in which the amino acid composition is close to that of human milk. An infant formula base having a total protein concentration of about 1.0 to about 1.5% and a β-casein concentration of at least about 11% of the total protein concentration is also disclosed. The infant formula base is suitable for the production of an infant formula.

### FIELD OF THE INVENTION

The invention relates to a method for producing a milk product. Particularly, the invention relates to a method for producing an infant formula base by means of membrane filtration techniques. The infant formula base of the invention is suitable for use in the production of an infant formula.

### BACKGROUND OF THE INVENTION

A need for an infant formula has always existed in situations where for some reason breastfeeding is impossible or human milk is insufficient. Bovine milk contains the same components (fat, casein, whey proteins, lactose, minerals) as human milk, but the components differ in concentrations. The amino acid compositions of β-casein and α-lactalbumin in bovine milk are highly similar to the amino acid compositions of β-casein and α-lactalbumin in human milk. However, the whey protein/casein ratio is different in bovine milk and in human milk; in bovine milk the ratio is 20:80 while in human milk it is 60:40. In order to adjust the amino acid composition of the protein of an infant formula to be as close as possible to the amino acid composition of human milk, the whey protein/casein ratio in the infant formula is typically adjusted to be the same as that in human milk.

Infant formulas are nowadays typically composed of powdered raw materials that are dissolved and mixed and dried again into an infant formula powder or sterilized and packaged as a liquid infant formula ready for instant use.

Infant formulas are typically produced from cheese whey as a source of lactose and protein. The three most important proteins in cheese whey are β-lactoglobulin, α-lactalbumin, and caseinomacropeptide (CMP) released from casein by a rennet. β-lactoglobulin and α-lactalbumin are useful proteins in an infant formula, but caseinomacropeptide deteriorates the amino acid composition of the proteins contained in whey and thus the suitability of whey proteins as raw material for an infant formula.

It is known that milk casein and whey protein can be separated from one another by microfiltration. When milk is filtered using 0.1 to 0.5 μm membranes, whey proteins penetrate through a membrane into a permeate whereas casein is retained in a retentate. The protein composition of an ideal whey produced by microfiltration differs from the composition of the conventional cheese whey e.g. such that the ideal whey contains no metabolism products of starters, such as lactic acid, that are released to the whey in cheese-making. Similarly, the release of caseinomacropeptides released by rennet enzymes from kappa casein to the whey is avoided. The most important types of protein in human milk are α-lactalbumin and β-casein. When the release of caseinomacropeptides to the whey is avoided, α-lactalbumin contained in the whey proteins forms a larger portion of the total protein. Thus, by using microfiltration it is possible to achieve a protein composition which is closer to that of human milk, compared to the use of cheese whey.

It has been disclosed that by means of microfiltration it is possible to produce an infant formula in which the amino acid composition is particularly suitable. WO 00/30461 describes a method for preparing an infant formula, wherein a permeate from microfiltration is concentrated and demineralized by electrodialysis and mixed with a microfiltration retentate or casein. A drawback of the method described in the WO document is that it is a complex process which requires intermediate dryings and pH-adjustment as well as an expensive and highly energy-consuming procedure of demineralization by electrodialysis.

### BRIEF DESCRIPTION OF THE INVENTION

We have surprisingly found that microfiltration together with other membrane filtration techniques enables an infant formula base with an excellent amino acid composition to be produced from fresh milk with no expensive demineralisation methods, intermediate dryings nor storage. A combination of microfiltration, ultrafiltration and nanofiltration enables milk to be split into a casein fraction, a whey protein fraction and a lactose fraction. These fractions can be combined in a desired manner and in appropriate proportions to provide an infant formula base in which the amino acid composition is close to that of human milk. When the infant formula base is supplemented with a suitable fat source and other necessary components, such as trace elements and vitamins, an infant formula which meets the requirements set by the EU food legislation is achieved.

The method according to the invention also enables an infant formula to be produced in which the total protein concentration is lower than the total protein concentration in the conventional infant formulas. It has become apparent that it would be desirable to decrease the protein concentration in the current infant formulas without, however, deteriorating their amino acid composition, because the protein concentration in these infant formulas is clearly higher than that in human milk. This may result in a child's undesired rapid growth. Excess protein also overstrains the child's metabolism unnecessarily.

An advantage of the method according to the invention is that no separate demineralisation by electrodialysis or ion exchange is necessary but milk is efficiently demineralised by membrane filtration. Neither does the method according to the invention comprise any intermediate drying phases of the prior art production methods that may cause harmful changes in the nutritive value of proteins, such as destruction of useful lycine, but the nutritional quality of the infant formula base produced in accordance with the invention is excellent. The method according to the invention does not employ any rennet, either, which enables the formation of undesired caseinomacropeptides to be avoided. The method according to the invention thus enables simple, cost-effective and efficient production of an infant formula base which is highly similar to human milk and in which the concentrations of different components can be easily adjusted as desired and in which the concentrations of the proteins α-lactalbumin and β-casein in particular can be optimized in an advantageous manner. The method according to the invention enables amino acid concentrations required by legislation to be achieved more easily than before. In addition, the method according to the invention makes it possible to provide an infant formula base with a mineral composition that as such is closer to the mineral composition of a final infant formula.

One advantage of the method according to the invention is that the method particularly conveniently enables the production of an organic infant formula base since it is possible to directly use organic milk as raw material. Another aspect of the invention provides an infant formula base having a total protein concentration of about 1.0 to about 1.5% and a β-casein concentration of at least about 11% of the total protein. Yet another aspect of the invention provides an infant formula base having a total protein concentration of about 1.0 to about 1.5% and a β-casein concentration of at least about 50% of the casein.

A still further aspect of the invention provides an infant formula comprising the infant formula base of the invention.

A still further aspect of the invention provides a use of the infant formula base of the invention or produced by the method of the invention or of the infant formula of the invention for producing other milk-containing foods for infants.

### BRIEF DESCRIPTION OF THE FIGURES

FIG. 1 illustrates an embodiment of the method according to the invention for the production of an infant formula base.

FIG. 2 shows concentrations of necessary amino acids in an infant formula base according to the invention as well as minimum amounts required by legislation.

### DETAILED DESCRIPTION OF THE INVENTION

An aspect of the invention provides a method for producing an infant formula base, comprising the steps of:

a) subjecting a milk raw material to microfiltration to provide a casein concentrate as a microfiltration retentate and a microfiltration permeate containing whey proteins,

b) subjecting the microfiltration permeate to ultrafiltration to provide a whey protein concentrate as an ultrafiltration retentate and an ultrafiltration permeate containing lactose and milk minerals,

c) subjecting the ultrafiltration permeate to nanofiltration to provide a lactose concentrate as a nanofiltration retentate and a nanofiltration permeate containing milk minerals,

d) composing an infant formula base from the whey protein concentrate, the lactose concentrate and a milk based fat containing liquid.

In the context of the present invention, the milk raw material refers to milk as such or as a concentrate or as pre-treated as desired, such as heat-treated. The milk raw material may be supplemented with ingredients generally used in the production of milk products, such as fat, protein, mineral and/or sugar fractions or the like. The milk raw material may thus be, for instance, whole milk, low-fat or skim milk, cream, ultrafiltered milk, diafiltered milk, micro-filtered milk, milk recombined from milk powder, organic milk or a combination or dilution of any of these. In an embodiment of the invention, the milk raw material is skim milk. In another embodiment, the milk raw material is whole milk.

The milk raw material may originate from a cow, sheep, goat, camel, horse, donkey or any other animal producing milk suitable for human nourishment.

In accordance with step a) of the method according to the invention, the milk raw material is subjected to microfiltration (MF) such that casein is retained in the MF retentate while whey proteins penetrate through the membrane into the MF permeate. Typically, microfiltration employs a polymeric or ceramic membrane having a porosity of about 0.1 to about 0.5 μm.

Microfiltration is typically performed with a concentration factor K=about 2 to about 10. The concentration factor K refers to the volumetric ratio of the liquid fed to the filtration to the retentate, and it is defined by the following formula:

K=feed (L)/retentate (L).

In an embodiment of the invention, diafiltration is used in connection with microfiltration to enhance separation of casein and whey proteins. Typically, tap water is used as diawater in diafiltration. Fractions obtained in different membrane filtrations of milk components may also be used as diawater. In diafiltration, the concentration factor may be considerably higher than that typically used in microfiltration.

The whey proteins in bovine milk mainly consist of β-lactoglobulin and α-lactalbumin. It is known that when bovine milk is heated, β-lactoglobulin begins to attach to casein. When milk is heavily heat-treated prior to microfiltration, a significant portion of β-lactoglobulin thus becomes attached to casein and does not penetrate the microfiltration membrane. Consequently, the α-lactalbumin concentration with respect to the total protein in the microfiltration permeate may be raised. Thus, when desired, the protein and amino acid composition of the microfiltration permeate used for composing the infant formula base may be adjusted advantageously by means of a heat treatment of the milk raw material. Denaturation of β-lactoglobulin and α-lactalbumin caused by a heat treatment is described in more detail in Example 2.

In an embodiment of the method of the invention, the milk raw material is heat-treated prior to microfiltration. In an embodiment of the invention, the heat treatment is performed at about 65 to about 95° C. for about 15 s to about 10 min. In a preferred embodiment of the invention, the heat treatment is performed at about 72 to about 90° C. for about 15 s.

The casein in human milk is mainly β-casein. It is known that the permeation of β-casein through a microfiltration membrane may be influenced by adjusting the filtration temperature; WO 2007/055932 discloses that if microfiltration is performed at a temperature below 10° C., β-casein partly penetrates through the microfiltration membrane. In addition to whey proteins, the microfiltration permeate may thus be enriched with β-casein. The use of such a microfiltration permeate for producing an infant formula base enables a protein composition to be achieved that is even closer to the protein composition of human milk.

Changing the temperature at which microfiltration is performed enables the permeation ability of β-casein through the microfiltration membrane to be adjusted and thus the protein composition formed in the microfiltration permeate to be influenced. Microfiltration can be carried out at room temperature or at a temperature lower or higher than that. Typically, the temperature range is about 5 to about 55° C. When microfiltration is performed at a temperature lower than room temperature, e.g. at about 5 to about 15° C., the membrane permeation ability of β-casein, i.e. its amount in the MF permeate, increases. When microfiltration is performed at a temperature higher than room temperature, e.g. at about 45 to about 55° C., β-casein primarily does not penetrate the microfiltration membrane but is retained in the MF retentate. In a preferred embodiment of the invention, microfiltration is performed at about 5 to about 15° C.

According to the present invention, by using microfiltration the protein composition of milk can be changed into a form which is beneficially close to the protein and amino acid composition of human milk and thus optimally suitable for producing an infant formula base. In an embodiment of the invention, the β-casein concentration in the infant formula base is at least about 11% of the total protein. In an embodiment of the invention, the β-casein concentration in the infant formula base is at least about 50% of the casein. This enables the amino acid concentrations required by legislation to be achieved more easily than before. Furthermore, it is possible to produce an infant formula base, and a final infant formula, having a lower protein concentration.

The microfiltration retentate containing casein in a concentrated form may be used for producing an infant formula base. It is also highly suitable for use as raw material in cheese-making.

Whey proteins collected in the microfiltration permeate are concentrated in accordance with step b) of the method according to the invention by subjecting the MF permeate to ultrafiltration (UF) to concentrate the whey proteins β-lactoglobulin and α-lactalbumin as well as β-casein possibly contained in the MF permeate into the UF retentate. The obtained UF retentate is used for producing an infant formula base. Lactose and milk minerals as well as other small molecule compounds penetrate the ultrafiltration membrane. In ultrafiltration, membranes with a cut-off value of about 1 to about 20 kDa are typically used. Ultrafiltration of the microfiltration permeate is typically performed with a concentration factor of about 10 to about 80.

In an embodiment of the invention, diafiltration is used in connection with ultrafiltration to enhance separation of the aforementioned components. Typically, tap water is used as diawater in diafiltration. Fractions obtained in different membrane filtrations of milk components may also be used as diawater.

Lactose contained in the UF permeate is separated in accordance with step c) of the method according to the invention by subjecting the UF permeate to nanofiltration. The lactose concentrates into the NF retentate while milk minerals and other small molecule compounds penetrate the nanofiltration membrane. The obtained NF retentate is used for producing an infant formula base. As in microfiltration and ultrafiltration, diafiltration may also be used in nanofiltration to enhance separation of lactose. Typically, tap water is used as diawater. Fractions obtained in different membrane filtrations of milk components may also be used as diawater.

The method according to the invention employs neither electrodialysis nor ion exchange for demineralisation.

In an embodiment of the invention, the method comprises a step of hydrolysing proteins to enable a hypoallergenic infant formula base to be produced. The hypoallergenic infant formula base can be used in the production of a hypoallergenic infant formula which is suitable for infants who are allergic to the proteins in bovine milk. In the hydrolysis of proteins, the proteins are hydrolysed enzymatically into small peptides that no longer cause allergic reactions. Hydrolysis may be carried out according to the known methods, by using protease enzymes widely known in the field. The hydrolysis of proteins may be performed in any suitable step during the method. In an embodiment of the invention, the hydrolysis of proteins is performed on the MF permeate prior to ultrafiltration. In another embodiment of the invention, the hydrolysis of proteins is performed on the MF permeate during ultrafiltration. In a still further embodiment of the invention, the hydrolysis of proteins is performed on the infant formula base composed in step d).

In an embodiment of the invention, the method comprises hydrolysing lactose to split the lactose into monosaccharides. Hydrolysis may be carried out using lactase enzymes widely used in the field and according to conventional methods in the field. The hydrolysis of lactose may be performed in any suitable step during the method. In an embodiment of the invention, the hydrolysis of lactose is performed on the MF permeate prior to ultrafiltration. In another embodiment of the invention, the hydrolysis of lactose is performed on the MF permeate during ultrafiltration. In a still further embodiment of the invention, the hydrolysis of lactose is performed on the infant formula base composed in step d).

Proteins and lactose may be hydrolysed simultaneously or in different steps.

In an embodiment of the invention, the method comprises a fermenting step or an acidifying step to produce an acidified infant formula base. The fermentation and acidification of the infant formula base may be carried out in a manner known per se. In an embodiment of the invention, the fermentation or acidification is performed on the infant formula base composed in step d).

In accordance with step d), an infant formula base is composed from the UF retentate, i.e. the whey protein concentrate, and the NF retentate, i.e. the lactose concentrate, obtained from step b) and c), respectively, and a milk based fat containing liquid.

The milk based fat containing liquid may be, e.g., the casein concentrate obtained from microfiltration of the milk raw material in step a) of the method of the invention, the milk raw material, milk with a standardized fat content, cream or a mixture thereof. In an embodiment, the milk based fat containing liquid is the casein concentrate.

In order to achieve a suitable infant formula, the infant formula base of the invention is supplemented with an extra fat fraction to provide a suitable fat composition to the formula. The extra fat fraction may be e.g. vegetable oil or another oil or any combination thereof. Typically, some mineral and trace elements still need to be added in order to provide an infant formula with an optimum composition. Typically, the mineral and trace elements to be supplemented are Fe, Zn, Cu, I, Se, and Ca.

The infant formula base produced in accordance with the invention may be heat-treated in a manner generally known in the field. The heat treatment may be pasteurization, high pasteurization, or heating at a temperature lower than the pasteurization temperature for a sufficiently long time. Particularly, UHT treatment (e.g. 138° C., 2 to 4 s), ESL treatment (e.g. 130° C., 1 to 2 s), pasteurization (e.g. 72° C., 15 s) or high pasteurization (95° C., 5 min) can be mentioned. The heat treatment may be either direct (vapour to milk, milk to vapour) or indirect (tube heat exchanger, plate heat exchanger, scraped-surface heat exchanger).

In an embodiment of the invention, the infant formula base is dried into a powder. The drying may be carried out by any method generally used in the field, such as spray drying. The infant formula base can be recombined into water to provide an infant formula base in liquid form.

Typically, the total protein concentration of the infant formula base produced in accordance with the invention is about 1.0 to about 1.5%. The carbohydrate concentration is typically about 6.0 to about 8.0%. The fat concentration is typically about 3.0 to about 5.0%.

The infant formula base produced in accordance with the invention can be formulated to an infant formula having an energy content of about 60 to about 70 kcal/100 g.

The ratio of whey protein to casein in the infant formula base may be adjusted to be about 50:50 to about 100:0. In an embodiment of the invention, the ratio is about 60:40 to about 80:20.

In an embodiment of the invention, the infant formula base is produced from the UF retentate and the NF retentate obtained in the method of the invention, milk, cream, vegetable fat and water.

In another embodiment, the infant formula base is produced from the MF retentate, the UF retentate and the NF retentate, obtained in the method of the invention, cream, vegetable fat and water.

In an embodiment, the R-casein concentration of the infant formula base produced in accordance with the invention is at least about 11% of the total protein.

In another embodiment, the R-casein concentration of the infant formula base produced in accordance with the invention is at least about 50% of the casein.

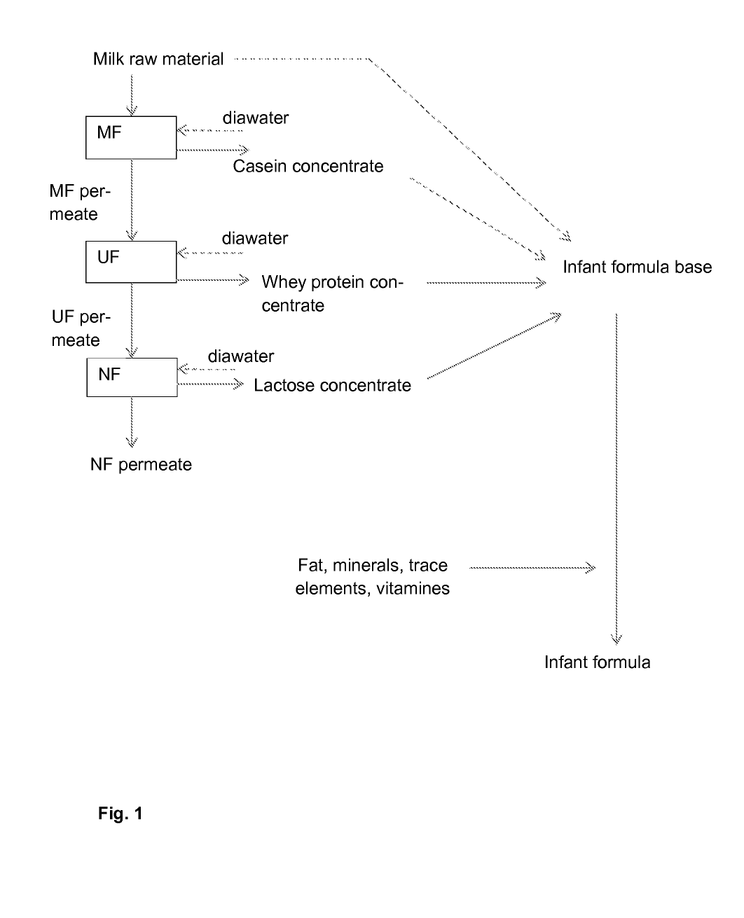

FIG. 1 describes an embodiment of the method of the invention for producing an infant formula base. A milk raw material is subjected to microfiltration (MF), the obtained microfiltration permeate is subjected to ultrafiltration (UF), and the obtained UF permeate is subjected to nanofiltration (NF). Optional procedures are shown in broken line in the figure. If desired, it is thus possible to use diafiltration in connection with the microfiltration, ultrafiltration and nanofiltration. An infant formula base is composed from the whey protein concentrate obtained in ultrafiltration and the lactose concentrate obtained in nanofiltration. The casein concentrate obtained from microfiltration and the milk raw material can be used in the production of the infant formula base. The infant formula base is combined with extra fat, minerals, trace elements and vitamin supplements to provide an infant formula with an optimum composition.

Another aspect of the invention provides an infant formula base having a total protein concentration of about 1.0 to about 1.5% and a β-casein concentration of at least about 11% of the total protein.

A still further aspect of the invention provides an infant formula base having a total protein concentration of about 1.0 to about 1.5% and a β-casein concentration of at least about 50% of the casein.

In an embodiment, the infant formula base of the invention is liquid.

The infant formula base produced in accordance with the invention may be supplemented with probiotics such as Lactobacillus LGG, prebiotics such as galacto-oligosaccharides, amino acids such as taurine, proteins such as lactoferrin, and nucleotides.

A still further aspect of the invention provides an infant formula comprising the infant formula base of the invention. In an embodiment, the infant formula further comprises mineral and trace elements and an extra fat fraction. In an embodiment, the energy content of the infant formula is about 60 to about 70 kcal/100 g.

The infant formula can be liquid or powder. In an embodiment of the invention, an infant formula is produced which completely meets the requirements set by the EU food legislation.

The infant formula base or the infant formula of the invention may be used for producing other infant foods, such as porridges and gruels. One aspect of the invention thus provides a use of an infant formula base of the invention or produced by the method of the invention or of the infant formula of the invention for producing other milk-containing baby foods (baby formula, liquid baby formula, growing-up milk, etc.).

The following examples are given to further illustrate the invention without, however, restricting the invention thereto.

### EXAMPLE 1

Skim milk (1 000 L) was microfiltered by polymeric filtration membranes (Synder FR) having a pore size of 800 kDa. The filtration temperature was 12° C. The milk was concentrated to a concentration factor of 3.3, followed by diafiltration. In the diafiltration step, a 1.5-fold amount of water was added to the microfiltration retentate. Water was added at the same rate as the permeate was collected. This gave 300 L of microfiltration retentate and 2 200 L of microfiltration permeate.

The microfiltration permeate was concentrated by ultrafiltration with 10 kDa membranes (Koch HFK-131) to a dry matter content of 12%. This gave 50 L of ultrafiltration retentate and 2 150 L of ultrafiltration permeate. The ultrafiltration permeate was further concentrated by nanofiltration to a dry matter content of 20%, followed by diafiltration. In the diafiltration step, a 1.5-fold amount of water was added to the nanofiltration retentate. Water was added at the same rate as the permeate was collected. This gave 540 L of nanofiltration retentate and 4 840 L of nanofiltration permeate.

End products of the filtration process were the microfiltration retentate, the ultrafiltration retentate, and the nanofiltration retentate. Table 1 describes the compositions of the obtained fractions.

TABLE 1
Compositions of filtration fractions

| Component | MF retentate | UF retentate | NF retentate |
|---|---|---|---|
| Protein (%) | 9.38 | 8.73 | 0.26 |
| Whey protein (%) | 0.33 | 6.52 | — |
| Casein (%) | 8.87 | 2.07 | — |
| Beta casein (%) | 3.00 | 1.36 | — |
| Lactose (%) | 0.41 | 1.88 | 16.73 |
| Ash (%) | 0.80 | 0.36 | 0.72 |
| Fat (%) | 0.10 | 0.05 | — |
| Dry matter (%) | 11.16 | 11.97 | 19.53 |

### EXAMPLE 2

Skim milk (1 000 L) was heat-treated by different methods (65° C. to 95° C., 15 s to 10 min) prior to a microfiltration step. The heat treatment of skim milk denatured β-lactoglobulin 1 to 90% and α-lactalbumin 0 to 26%. Heat treatment at 72° C. for 15 s denatured both β-lactoglobulin and α-lactalbumin less than 10%. Heat treatment at 80° C. for 15 s denatured β-lactoglobulin 14% and α-lactalbumin again less than 10%. Heat treatment at 90° C. for 15 s denatured β-lactoglobulin already 35%, and the denaturation of α-lactalbumin still remained unchanged. Only undenatured whey protein penetrates the microfiltration membrane, so a pre-heat-treatment may be used for influencing the protein composition of the microfiltration permeate.

### EXAMPLE 3

An infant formula was composed from the UF retentate and NF retentate obtained in Example 1, as well as skim milk, cream and vegetable fat in accordance with Table 2. The whey protein/casein ratio used in the formula was 60/40. The energy content of the formula was 65 kcal/100 g. 17% of the protein in the formula was beta casein. 53% of the casein in the formula was beta casein.

TABLE 2
Composition of infant formula

| | | | | | Vegetable | | |
|---|---|---|---|---|---|---|---|
| Component | Milk | UF retentate | Water | Cream | fat | NF retentate | Product |
| Proportion | 4.65 | 12.18 | 38.59 | 3.97 | 2.10 | 38.51 | 100 |
| (%) | | | | | | | |
| Protein (%) | 3.40 | 8.73 | — | 2.00 | — | 0.26 | 1.40 |
| Whey protein | 0.68 | 6.52 | — | 0.40 | — | — | 0.84 |
| (%) | | | | | | | |
| Casein (%) | 2.72 | 2.07 | — | 1.60 | — | — | 0.44 |
| Beta casein | 1.00 | 1.36 | — | 0.59 | — | — | 0.24 |
| (%) | | | | | | | |
| Lactose (%) | 4.64 | 1.88 | — | 2.80 | — | 16.73 | 7.00 |
| Ash (%) | 0.77 | 0.36 | 0.08 | 0.50 | — | 0.72 | 0.41 |
| Fat (%) | 0.05 | 0.05 | — | 35.00 | 100 | — | 3.50 |

### EXAMPLE 4

An infant formula was composed from the MF retentate, UF retentate, and NF retentate obtained in Example 1, as well as cream and vegetable fat in accordance with Table 3. The whey protein/casein ratio used in the formula was 60/40. The energy content of the formula was 65 kcal/100 g. 16% of the protein in the formula was beta casein. 53% of the casein in the formula was beta casein.

TABLE 3
Composition of infant formula

| | | | | | Vegetable | | |
|---|---|---|---|---|---|---|---|
| Component | MF retentate | UF retentate | Water | Cream | fat | NF retentate | Product |
| Proportion | 1.27 | 12.57 | 40.37 | 3.97 | 2.10 | 39.72 | 100 |
| (%) | | | | | | | |
| Protein (%) | 9.38 | 8.73 | — | 2.00 | — | 0.26 | 1.40 |
| Whey protein | 0.33 | 6.52 | — | 0.40 | — | — | 0.84 |
| (%) | | | | | | | |
| Casein (%) | 8.87 | 2.07 | — | 1.60 | — | — | 0.44 |
| Beta casein | 3.00 | 1.36 | — | 0.54 | — | — | 0.23 |
| (%) | | | | | | | |
| Lactose (%) | 0.41 | 1.88 | — | 2.80 | — | 16.73 | 7.00 |
| Ash (%) | 0.80 | 0.36 | 0.08 | 0.50 | — | 0.72 | 0.39 |
| Fat (%) | 0.10 | 0.05 | — | 35.00 | 100 | — | 3.50 |

### EXAMPLE 5

Milk containing 3.5% fat (1 000 L) was microfiltered, ultrafiltered, and nanofiltered in a manner described in Example 1, except that the microfiltration was carried out at a temperature of 50° C.

An infant formula was composed from the MF retentate (filtrated at 50° C.), and from the UF retentate and NF retentate obtained in Example 1, as well as milk and vegetable fat in accordance with Table 4. The whey protein/casein ratio used in the formula was 60/40. The energy content of the formula was 65 kcal/100 g. 17% of the protein in the formula was beta casein. 54% of the casein in the formula was beta casein.

TABLE 4
Composition of infant formula

| | | | | | Vegetable | | |
|---|---|---|---|---|---|---|---|
| Component | MF retentate | UF retentate | Water | Milk | fat | NF retentate | Product |
| Proportion (%) | 1.58 | 12.58 | 41.09 | 1.58 | 3.22 | 39.95 | 100 |
| Protein (%) | 9.38 | 8.73 | — | 3.20 | — | 0.26 | 1.40 |
| Whey protein (%) | 0.33 | 6.52 | — | 0.64 | — | — | 0.84 |
| Casein (%) | 8.98 | 2.07 | — | 2.56 | — | — | 0.44 |
| Beta casein (%) | 3.30 | 1.36 | — | 0.94 | — | — | 0.24 |
| Lactose (%) | 0.41 | 1.88 | — | 4.64 | — | 16.73 | 7.00 |
| Ash (%) | 0.80 | 0.36 | 0.08 | 0.77 | — | 0.72 | 0.39 |
| Fat (%) | 11.6 | 0.05 | — | 6.00 | 100 | — | 3.50 |

### EXAMPLE 6

Milk containing 3.5% fat (1 000 L) was microfiltered, ultrafiltered, and nanofiltered in a manner described in Example 1, except that the microfiltration was carried out at a temperature of 50° C.

An infant formula was composed from the MF retentate (filtrated at 50° C.), and from the UF retentate and NF retentate obtained in Example 1, as well as vegetable fat in accordance with Table 5. The whey protein/casein ratio used in the formula was 60/40. The energy content of the formula was 65 kcal/100 g. 17% of the protein in the formula was beta casein. 54% of the casein in the formula was beta casein.

TABLE 5
Composition of infant formula

| | | | | Vegetable | | |
|---|---|---|---|---|---|---|
| Component | MF retentate | UF retentate | Water | fat | NF retentate | Product |
| Proportion (%) | 1.99 | 12.71 | 41.66 | 3.26 | 40.38 | 100 |
| Protein (%) | 9.38 | 8.73 | — | — | 0.26 | 1.40 |
| Whey protein (%) | 0.33 | 6.52 | — | — | — | 0.84 |
| Casein (%) | 8.98 | 2.07 | — | — | — | 0.44 |
| Beta casein (%) | 3.30 | 1.36 | | — | | 0.24 |
| Lactose (%) | 0.41 | 1.88 | — | — | 16.73 | 7.00 |
| Ash (%) | 0.80 | 0.36 | 0.08 | — | 0.72 | 0.39 |
| Fat (%) | 11.6 | 0.05 | — | 100 | — | 3.50 |

### EXAMPLE 7

Skim milk (1 000 L) was microfiltered, ultrafiltered, and nanofiltered in a manner described in Example 1, except that the microfiltration was carried out at a temperature of 15° C.

An infant formula was composed from the UF retentate and the NF retentate separated by the filtrations, as well as cream and vegetable fat in accordance with Table 6. The whey protein/casein ratio used in the formula was 80/20. The energy content of the formula was 60 kcal/100 g. 11% of the protein in the formula was beta casein. 51% of the casein in the formula was beta casein.

TABLE 6
Composition of infant formula

| | | | | Vegetable | | |
|---|---|---|---|---|---|---|
| Component | UF retentate | Water | Cream | fat | NF retentate | Product |
| Proportion | 11.61 | 48.17 | 3.97 | 2.10 | 39.72 | 100 |
| (%) | | | | | | |
| Protein (%) | 8.79 | — | 2.00 | — | 0.26 | 1.19 |
| Whey protein | 7.00 | — | 0.40 | — | — | 0.83 |
| (%) | | | | | | |
| Casein (%) | 1.65 | — | 1.60 | — | — | 0.26 |
| Beta casein | 0.94 | — | 0.54 | — | — | 0.13 |
| (%) | | | | | | |
| Lactose (%) | 1.60 | — | 2.80 | — | 16.73 | 6.01 |
| Ash (%) | 0.36 | 0.08 | 0.50 | — | 0.72 | 0.35 |
| Fat (%) | 0.05 | — | 35.00 | 100 | — | 3.50 |

Despite the low protein concentration in the product, the infant formula according to Table 6 meets the requirements set by the EU legislation for necessary amino acids without any amino acid supplements.

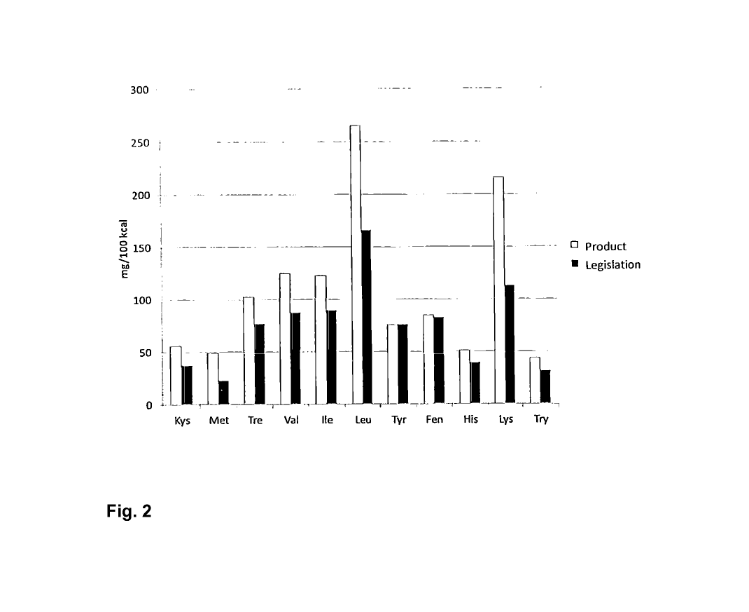

FIG. 2 shows the amino acid composition of the infant formula according to Table 6. The values prescribed by legislation represent the required minimum concentration of each amino acid.

### EXAMPLE 8

Skim milk (1 000 L) was microfiltered, ultrafiltered, and nanofiltered in a manner described in Example 1, except that the microfiltration was carried out at a temperature of 15° C.

An infant formula was composed from the MF retentate, UF retentate and the NF retentate separated by the filtrations, as well as vegetable fat in accordance with Table 7. The whey protein/casein ratio used in the formula was 75/25. The energy content of the formula was 60 kcal/100 g. 11% of the protein in the formula was beta casein. 50% of the casein in the formula was beta casein.

TABLE 7
Composition of infant formula

| | | UF | | Vegetable | | |
|---|---|---|---|---|---|---|
| Component | MF retentate | retentate | Water | fat | NF retentate | Product |
| Proportion (%) | 0.92 | 11.61 | 50.10 | 3.49 | 34.80 | 100 |
| Protein (%) | 9.38 | 8.79 | 0.00 | — | 0.26 | 1.20 |
| Whey protein (%) | 0.33 | 7.00 | 0.00 | — | 0.00 | 0.82 |
| Casein (%) | 8.87 | 1.65 | 0.00 | — | 0.00 | 0.27 |
| Beta casein (%) | 3.00 | 0.94 | | — | — | 0.14 |
| Lactose (%) | 0.41 | 1.60 | 0.00 | — | 16.73 | 6.01 |
| Ash (%) | 0.80 | 0.36 | 0.08 | — | 0.72 | 0.34 |
| Fat (%) | 0.05 | 0.05 | | 100 | 0.00 | 3.50 |

Despite the low protein concentration in the product, the infant formula according to Table 7 meets the requirements set by the EU legislation for necessary amino acids without any amino acid supplements.

It will be apparent to a person skilled in the art that as technology advances, the basic idea of the invention may be implemented in many different ways. The invention and its embodiments are thus not restricted to the examples described above but may vary within the scope of the claims.

1.-22. (canceled)

23. A method for producing an infant formula base, the method comprising the following steps of:
a) subjecting a milk raw material to microfiltration to provide a casein concentrate as a microfiltration retentate and a microfiltration permeate containing whey proteins,
b) subjecting the microfiltration permeate to ultrafiltration to provide a whey protein concentrate as an ultrafiltration retentate and an ultrafiltration permeate containing lactose and milk salts,
c) subjecting the ultrafiltration permeate to nanofiltration to provide a lactose concentrate as a nanofiltration retentate and a nanofiltration permeate containing milk salts,
d) composing an infant formula base having a total protein concentration of about 1.0 to about 1.5% from the whey protein concentrate, the lactose concentrate and a milk based fat containing liquid.

24. The method of claim 23, wherein the milk raw material is skim milk.

25. The method of claim 23, wherein diafiltration is used in microfiltration, ultrafiltration and/or nanofiltration with water as diawater.

26. The method of claim 23, wherein no electrodialysis nor ion exchange is used for demineralisation.

27. The method of claim 23, wherein the milk raw material is heat-treated prior to microfiltration at about 65 to about 95° C. for about 15 s to about 10 min, preferably at about 72 to about 90° C. for about 15 s.

28. The method of claim 23, wherein microfiltration is performed at a temperature of about 5 to about 15° C.

29. The method of claim 23, wherein the infant formula base is produced in which the β-casein concentration is at least about 11% of the total protein concentration.

30. The method of claim 23, wherein the infant formula base is produced in which the β-casein concentration is at least about 50% of the casein concentration.

31. The method of claim 23, wherein the whey protein/casein ratio of the infant formula base is adjusted to be about 50:50 to about 100:0, preferably about 60:40 to about 80:20.

32. The method of claim 23, comprising a step of hydrolysing proteins.

33. The method of claim 32, wherein the hydrolysis of proteins is performed on the MF permeate.

34. The method of claim 23, comprising a step of hydrolysing lactose.

35. The method of claim 34, wherein the hydrolysis of lactose is performed on the infant formula base composed in step d).

36. The method of claim 23, wherein the infant formula base is dried into a powder.

37. The method of claim 23, wherein the infant formula base is formulated to an infant formula having an energy content of about 60 to about 70 kcal/100 g.

38. An infant formula base having a total protein concentration of about 1.0 to about 1.5% and a β-casein concentration of at least about 11% of the total protein concentration.

39. An infant formula base having a total protein concentration of about 1.0 to about 1.5% and a β-casein concentration of at least about 50% of the casein concentration.

40. The infant formula base of claim 38, wherein the infant formula base is liquid.

41.-44. (canceled)
